(19) United States
(12) Patent Application Publication
(10) Pub. No.: US 2022/0222728 A1
(43) Pub. Date: Jul. 14, 2022

(54) SYSTEMS AND METHODS FOR PROVIDING PERSONALIZED RECOMMENDATIONS

(71) Applicant: Walmart Apollo, LLC, Bentonville, AR (US)

(72) Inventors: Shubham Gupta, Sunnyvale, CA (US); Yokila Arora, Sunnyvale, CA (US); Gaoyang Wang, San Jose, CA (US); Aditya Mantha, San Jose, CA (US); Anirudha Sundaresan, Sunnyvale, CA (US); Sneha Gupta, Mountain View, CA (US); Praveenkumar Kanumala, Newark, CA (US); Stephen Dean Guo, Saratoga, CA (US); Kannan Achan, Saratoga, CA (US)

(21) Appl. No.: 17/147,344

(22) Filed: Jan. 12, 2021

(51) Int. Cl. G06Q 30/06; G06Q 30/02

(52) U.S. Cl. CPC G06Q 30/0631; G06Q 30/0643; G06Q 30/0201; G06Q 30/0257

(57) ABSTRACT

This application relates to apparatus and methods for automatically determining and providing personalized digital recommendations including sponsored items. In some examples, a computing device receives a recommendation request. In response, the computing device determines an initial set of items for recommendation based on a relevance of associated items to the user and potential revenue from user interactions with the associated items. The computing device then generates final item recommendations by replacing at least one item of the initial set of items with a closest sponsored item that is selected based on a similarity of the closest sponsored item to the corresponding item. The final item recommendations are then presented to the user.

### TECHNICAL FIELD

The disclosure relates generally to digital recommendations and, more specifically, to electronically determining and providing personalized digital recommendations including sponsored items.

### BACKGROUND

At least some websites, such as retailer websites (e.g., e-commerce platforms), display item recommendations including relevant and sponsored items (e.g., advertisements). For example, a website may display item recommendations, and may further allow a customer to purchase recommended items. The displayed recommendations may be determined by recommendation systems, which may attempt to provide recommendations for items which the customer may be interested in. Some websites provide sponsored items as recommendations in fixed positions, in a global and static manner, for all user, for all transactions. For example, some websites provide sponsored items at the beginning and/or top of the page prior to other item recommendations determined based on relevancy. Some websites use carousels and corresponding panes to organize the item recommendations based on page limits. For example, a pane may include a set number of item recommendations within a carousel, and a page may have a set number of overall item recommendations. In an example, a featured items carousel may include a set number of sponsored items at the beginning of the carousel. However, presenting sponsored items in fixed positions without optimizing for relevancy may lead to a decreased overall revenue when other items that the user is more likely to purchase could have been presented in more optimal, easy to notice positions. In this way, in some examples, the item recommendation systems may provide recommendations for items that the customer finds irrelevant or is not interested in at positions that the user is most likely to interact with, losing out on revenue that may have been collected with other more relevant items recommended in those positions. In some examples, the customer may even be embarrassed by a displayed recommendation.

As a result, a retailer may lose sales of items to a customer. For example, the customer may not buy the recommended item, such as a presented sponsored item. In addition, the customer may leave the website without having purchased an item that, if shown a recommendation for, the customer would have purchased. In some examples, if a customer perceives a recommendation as irrelevant or embarrassing, the customer may go elsewhere, such as another website, to make purchases. As such, there are opportunities to address item recommendation systems, particularly related to the presentation of sponsored items in an optimized manner to maximize revenue from sale of sponsored items without compromising on relevancy of the recommendations.

### SUMMARY

The embodiments described herein are directed to automatically determining and providing personalized digital item recommendations with sponsored items at optimized positions for display, for example, on a website. The embodiments may allow a person, such as a customer, to be presented with item recommendations, including sponsored items and non-sponsored items, at personalized positions that may be more likely to interest the customer. For example, the embodiments may allow the person to view recommendations with sponsored and non-sponsored items, at personalized positions, that the person may be more willing to purchase. In some examples, the embodiments may provide ranking processes that rank sponsored and non-sponsored products in an efficient and accurate manner to increase sponsorship value while maintaining relevancy of the recommendations. The ranking processes may determine the items for recommendations and their corresponding positions based on relevancy scores, cost to click on sponsored items score, and similarities between relevant items and other sponsored items. In some examples, the recommendations are personalized to each person, e.g., the order of items is personalized to each person. As a result, the embodiments may allow a retailer to present more relevant sponsored items and non-sponsored with item recommendations to each person in more relevant positions, thereby increasing the chances that the person will purchase the recommended items. In addition, because a person may now spend less time reviewing irrelevant recommendations, the person may have additional time to consider additional items for purchase. Further, instead of randomly choosing sponsored items to recommend, recommending relevant sponsored items may increase revenue from sponsorships as well. In addition to or instead of these example advantages, persons of ordinary skill in the art having the benefit of these disclosures would recognize and appreciate other advantages as well.

In accordance with various embodiments, exemplary systems may be implemented in any suitable hardware or hardware and software, such as in any suitable computing device. For example, in some embodiments, a computing device is configured to receive one or more recommendation requests related to a user. The computing device is configured to obtain one or more associated items for the user, each associated item may correspond with a relevant association for the user and a potential revenue amount form a user interaction. The one or more associated items may be obtained using the one or more recommendation requests. The computing device is further configured to determine an initial set of items (e.g., with at least one sponsored item and one non-sponsored item) for recommendation based at least in part on the relevant association and the potential revenue amount. The computing device is also configured to obtain one or more sponsored items from a database. The computing device is configured to compare sponsored items to at least one initial item of the initial set of items to determine similarities between the at least one initial item and the sponsored items. Further, the computing device is configured to determine a closest sponsored item to the at least one initial item based on the comparison. The computing device is then configured to generate a final set of item recommendations by replacing the at least one initial item in the initial set of items with the closest sponsored item. Additionally, the computing device is configured to transmit the item recommendations for display to the user.

In some examples, the computing device may be further configured to determine a relevance score (e.g., relevance of the item to the user) and a cost score (e.g., earning per each interaction with a sponsored item) of each associated item for recommendation including the initial set of items. The computing device may generate total relevance scores based on the relevance scores and the cost scores and determine the initial set of items from the associated items based on the corresponding total relevance scores. In some examples, the initial set of items may also be determined based in part on a predetermined carousel limit, pane limit, and page limit. In some examples, the at least one item for replacement with the corresponding closest sponsored item is selected from the initial set of items at random. Computing device may further replace the at least one initial item with the closest sponsored item based on an item and sponsored-item embedding generated based on semantic similarity.

In some embodiments, a method is provided that includes receiving one or more recommendation requests related to a user. The method includes obtaining one or more associated items for the user, each associated item may correspond with a relevant association for the user and a potential revenue amount form a user interaction. The one or more associated items may be obtained using the one or more recommendation requests. The method further includes determining an initial set of items (e.g., with at least one sponsored item and one non-sponsored item) for recommendation based at least in part on the relevant association and the potential revenue amount. The method also includes obtaining one or more sponsored items from a database. The method includes comparing the sponsored items to at least one initial item of the initial set of items to determine similarities between the at least one initial item and the sponsored items. Further, the method includes determining a closest sponsored item to the at least one initial item based on the comparison. The method then includes generating a final set of item recommendations by replacing the at least one initial item in the initial set of items with the closest sponsored item. Additionally, the method includes transmitting the item recommendations for display to the user.

In yet other embodiments, a non-transitory computer readable medium has instructions stored thereon, where the instructions, when executed by at least one processor, cause a computing device to perform operations that include receiving one or more recommendation requests related to a user. The operations include obtaining one or more associated items for the user, each associated item may correspond with a relevant association for the user and a potential revenue amount form a user interaction. The one or more associated items may be obtained using the one or more recommendation requests. The operations further include determining an initial set of items (e.g., with at least one sponsored item and one non-sponsored item) for recommendation based at least in part on the relevant association and the potential revenue amount. The operations also include obtaining one or more sponsored items from a database. The operations include comparing the sponsored items to at least one initial item of the initial set of items to determine similarities between the at least one initial item and the sponsored items. Further, the operations include determining a closest sponsored item to the at least one initial item based on the comparison. The operations then include generating a final set of item recommendations by replacing the at least one initial item in the initial set of items with the closest sponsored item. Additionally, the operations includes transmitting the item recommendations for display to the user.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item recommendation system that includes an item recommendation computing device in accordance with some embodiments;

FIG. 2 is a block diagram of the item recommendation computing device of FIG. 1 in accordance with some embodiments;

FIG. 3 is a block diagram illustrating various portions of the item recommendation system of FIG. 1 in accordance with some embodiments;

FIG. 4 is a block diagram illustrating various portions of the item recommendation computing device of FIG. 1 in accordance with some embodiments;

FIG. 5 is a flowchart of an example method that can be carried out by the item recommendation computing device of FIG. 1 in accordance with some embodiments; and

FIG. 6 is a flowchart of another example method that can be carried out by the item recommendation computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

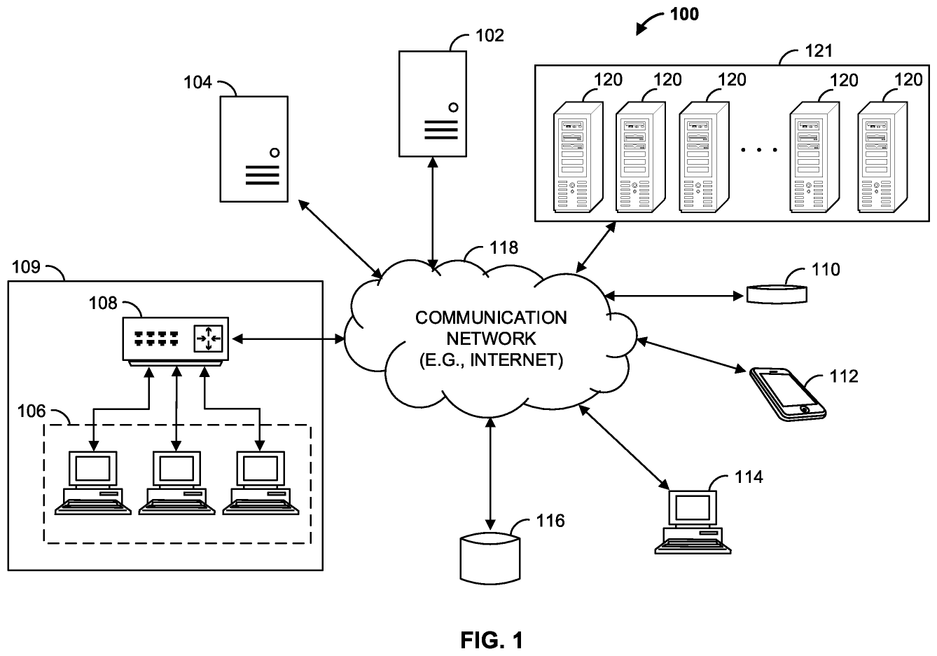

Turning to the drawings, FIG. 1 illustrates a block diagram of an item recommendation system 100 that includes an item recommendation computing device 102 (e.g., a server, such as an application server), a web server 104, one or more processing devices 120, workstation(s) 106, database 116, and one or more customer computing devices 110, 112, 114 operatively coupled over network 118. Item recommendation computing device 102, web server 104, workstation(s) 106, processing device(s) 120, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over communication network 118.

In some examples, each of item recommendation computing device 102 and processing device(s) 120 can be a computer, a workstation, a laptop, a server such as a cloud-based server, or any other suitable device. In some examples, each of processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of one or more processing devices 120 are offered as a cloud-based service (e.g., cloud computing). For example, cloud-based network 121 may offer computing and storage resources of one or more processing devices 120 to item recommendation computing device 102.

In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, web server 104 hosts one or more retailer websites. In some examples, item recommendation computing device 102, processing devices 120, and/or web server 104 are operated by a retailer, and multiple customer computing devices 112, 114 are operated by customers of the retailer. In some examples, processing devices 120 are operated by a third party (e.g., a cloud-computing provider).

Workstation(s) 106 are operably coupled to communication network 118 via router (or switch) 108. Workstation(s) 106 and/or router 108 may be located at a store 109, for example. Workstation(s) 106 can communicate with item recommendation computing device 102 over communication network 118. The workstation(s) 106 may send data to, and receive data from, item recommendation computing device 102. For example, the workstation(s) 106 may transmit data identifying items purchased by a customer at store 109 to item recommendation computing device 102.

Although FIG. 1 illustrates three customer computing devices 110, 112, 114, item recommendation system 100 can include any number of customer computing devices 110, 112, 114. Similarly, item recommendation system 100 can include any number of item recommendation computing devices 102, processing devices 120, workstations 106, web servers 104, and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, each of multiple computing devices 110, 112, 114 may be operable to view, access, and interact with a website, such as a retailer's website, hosted by web server 104. Web server 104 may transmit user session data related to a customer's activity (e.g., interactions) on the website. For example, a customer may operate one of customer computing devices 110, 112, 114 to initiate a web browser that is directed to the website hosted by web server 104. The customer may, via the web browser, view item recommendations for items displayed on the website, and may click on item advertisements, for example. The website may capture these activities as user session data, and transmit the user session data to item recommendation computing device 102 over communication network 118. The website may also allow the operator to add one or more of the items to an online shopping cart, and allow the customer to perform a “checkout” of the shopping cart to purchase the items. In some examples, web server 104 transmits purchase data identifying items the customer has purchased from the website to item recommendation computing device 102.

In some examples, item recommendation computing device 102 may execute one or more models (e.g., algorithms), such as a machine learning model, statistical model, logarithmic model, language model, etc., to determine recommended items to advertise to the customer (i.e., item recommendations). Item recommendation computing device 102 may transmit the item recommendations to web server 104 over communication network 118, and web server 104 may display advertisements for one or more of the recommended items on the website to the customer. For example, web server 104 may display the item advertisements to the customer on a homepage, a catalog webpage, an item webpage, or a search results webpage of the website (e.g., as the customer browses those respective webpages).

In some examples, web server 104 transmits a recommendation request (e.g., search request) to item recommendation computing device 102. The recommendation request may identify a recommendation or search query provided by the customer (e.g., via a search bar of the web browser), or a recommendation query provided by a processing unit in response to user adding one or more items to cart or interacting (e.g., engaging) with one or more items. In response to receiving the request, item recommendation computing device 102 may execute the one or more processors to determine search results or recommendation results to display to the customer (i.e., item recommendations). Item recommendation computing device 102 may transmit the results to web server 104 over communication network 118. Web server 104 may display the results on a results webpage, for example.

Item recommendation computing device 102 is further operable to communicate with database 116 over communication network 118. For example, item recommendation computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item recommendation computing device 102, in some examples, database 116 can be a local storage device, such as a hard drive, a non-volatile memory, or a USB stick. Item recommendation computing device 102 may store purchase data received from web server 104 in database 116. Item recommendation computing device 102 may also receive from web server 104 user session data identifying events associated with browsing sessions, and may store the user session data in database 116.

In some examples, item recommendation computing device 102 generates feature vectors for a plurality of models (e.g., machine learning models, statistical models, algorithms, etc.) based on item catalog data, historical user session data, purchase data, and current user session data for the user and/or items. Item recommendation computing device 102 trains the models based on their corresponding feature vectors, and item recommendation computing device 102 stores the models in a database, such as in database 116 (e.g., cloud storage).

The models, when executed by item recommendation computing device 102, allow item recommendation computing device 102 to determine item recommendations for one or more items to advertise to a customer. For example, item recommendation computing device 102 may obtain the models from database 116. Item recommendation computing device 102 may then receive, in real-time from web server 104, current user session data identifying real-time events of the customer interacting with a website (e.g., during a browsing session). In response to receiving the user session data, item recommendation computing device 102 may execute the models to determine item recommendations for items (e.g., sponsored items and non-sponsored items) to display to the customer.

In some examples, item recommendation computing device 102 receives current user session data from web server 104. The user session data may identify actions (e.g., activity) of the customer on a website. For example, the user session data may identify item impressions, item clicks, items added to an online shopping cart, conversions, click-through rates, item recommendations viewed, and/or item recommendations clicked during an ongoing browsing session (e.g., the user data identifies real-time events). Item recommendation computing device 102 may generate item recommendations based on the user session data, historical user data (e.g., historical user transaction data, historical user engagement data), active sponsored items available, potential revenues for sponsored items, item catalogs, page limits, carousel limits and/or pane limits. For example, item recommendation computing device 102 may determine relevant items for recommendation as an initial matter based on relevance of the corresponding items to the user (e.g., based on user session data, historical user data) and potential revenues corresponding to user interaction with corresponding sponsored items. The items may be ranked and/or assigned positions for display based on sponsored ads limits for a carousel, pane and page. The item recommendation computing device 102 may then replace one or more of the items for recommendation with closest similar sponsored items if the sponsored item limits for page, carousel, and/or page has not been met. The items to replace may be selected randomly. Semantic tensors (e.g., embedding vectors, feature vectors) of the items and sponsored items may be used to determine the sponsored item to replace the corresponding initial item with.

In some examples, the tensors are generated based on semantic similarities between the items and sponsored items. For example, item recommendation computing device 102 may generate the tensors based on a universal sentence encoding using a semantic similarity model that encodes and embeds item attributes such as title, brand, department, category, etc. (e.g., metadata) of the items and the sponsored items as extracted by analyzing the catalogs for each items and sponsored item. For example, item recommendation computing device 102 may generate the tensors based on catalog data for all items (e.g., sponsored items, non-sponsored items) as stored in database 116.

In some examples, item recommendation computing device 102 may also generate tensors based on semantic similarities between items (e.g., sponsored items, non-sponsored items). The tensors may be used to rank and score all items based on relevancy to the user for user session. The initial set of items for recommendation may then determine initial scores and/or ranks for the items based on the relevancy scores and cost scores (e.g., cost-per-click score for each sponsored item.

Item recommendation computing device 102 may provide the tensors (e.g., embeddings) as required by each machine learning model. The machine learning models may include, for example, neural networks, deep neural networks, decision tree models, regression models, random forest models, statistical models, stochastic models, or any other suitable models.

In some examples, item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units.

Based on the output of the models, item recommendation computing device 102 may generate item recommendations for items (e.g. sponsored and non-sponsored items) to be advertised on the website. For example, item recommendation computing device 102 may transmit the item recommendations to web server 104, and web server 104 may display the recommend items to the customer.

In some examples, item recommendation computing device 102 may rank items for recommendation based on balancing the expected revenue from the sponsored items and relevancy of the item recommendations. For example, the balancing may be dependent on relevancy of the item to the user, the revenue per interaction with each sponsored item, the user session, and the position that the item is shown in the recommendations. A highly relevant item shown at a position that the user is unlikely to scroll to may not result in sale of the item.

In some examples, item recommendation computing device 102 may determine a position, ωᵢⱼₖ, for an item for recommend at k^{th} item position of the j^{th} pane and the i^{th} carousel, where a website page for presenting recommendations may include multiple carousels, each carousel includes multiple panes of a fixed width, w, and each pane includes a list of ranked items. A position of each carousel, i, within a website page may be represented as i∈I={1, 2, . . . , I}, a position of a pane within a carousel may be represented as j∈J={1, 2, . . . , J}, and a position of a ranked item within the pane may be represented as k∈K={1, 2, . . . , K}. In some examples, position of an item ωᵢⱼₖ in a carousel, i, may be obtained by j×w+k. Each item may also be associated with a relevance score, r_{w}_{ᵢⱼₖ}, indicating a relevance of the item to the customer. The relevance scores may be stored in database 116.

In some examples, item recommendation computing device 102 may obtain data corresponding to sponsored items available for recommendation at the time of the recommendation request from database 116. The sponsored items data may include available sponsored items (e.g., advertisements) and corresponding cost-per-click score (i.e., cost score) indicating a revenue per interaction with the corresponding sponsored item. The sponsored items may be represented as a∈A={1, 2, . . . , A}, where each sponsored item, a, may be associated with a corresponding cost score, π_{w}_{ᵢⱼₖ}.

In some examples, item recommendation computing device 102 may determine initial scores of the items for recommendation based on the corresponding relevance scores and the cost scores. In some examples, cost scores for non-sponsored items may be determined to be zero. A boosting model may be used to determine the initial set of items for recommendation along with their positions based on predetermined constraints (e.g., page limit, carousel limit, pane limit) related to a number of sponsored items that may be presented to the user as recommendations. One or more of the initial set of items for recommendation may then be replaced with a corresponding closest similar sponsored item if one or more constraints have not been met. Item and sponsored item embeddings may be used to determine a closest sponsored item to the initial item. In this way, the two steps may be tractable and provide inference with low latency in real-time.

### Determining Initial Set of Items for Recommendation

In some examples, item recommendation computing device 102 may determine initial set of items for recommendation by boosting sponsored items from a set of relevant items relevant to the customer based on cost scores, to maximize the revenue from sponsored items without compromising on the relevancy of the recommendations to the user. First, item recommendation computing device may determine a set of relevant items for recommendation based on relevancy scores indicating relevancy of the items to the users. The items may include all items available on the website, including both sponsored and non-sponsored users. Any known recommendation or relevancy model (e.g., algorithm) may be used to determine the relevancy scores of the items. A total relevance score, sᵢⱼₖ, for an item may then be determined by combining the item's relevancy score, r_{ω}_{ᵢⱼₖ} and the item's cost score, π_{ω_ijk}. In some examples, the total relevance score may be determined as a linear combination of the relevancy score and the cost score. In some examples, the total relevance score, sᵢⱼₖ, for an item may be determined as follows:

sᵢⱼₖ=α*ψ(r_{w}_{ᵢⱼₖ})+(1−α)*ψ′(π_{w}_{ᵢⱼₖ}) eq. 1

where ψ(.) and ψ′(.) represents normalization function (e.g., sigmoid functions), α represents a weight of the linear combination such that the total relevancy scores may be between zero and one, and ijk index denotes the k^{th} position of the item in the j^{th} pane of the i^{th} carousel. In some examples, the cost score for non-sponsored items may be zero.

In some examples, item recommendation computing device 102 may find an initial set of items for recommendation based on one or more constraints on sponsored items that may be presented on the website page. For example, the constraints may include a pane limit that indicates a maximum number of sponsored items that may be presented in a pane within a carousel, a carousel limit that indicates a maximum number of sponsored items that may be presented in a carousel, and a page limit that indicates a maximum number of sponsored items that may be presented within the entire website page.

In some examples, item recommendation computing device 102 may determine whether to boost a sponsored item to a better position using a greedy approach. An optimal initial set of items for recommendation may be determined using an integer linear algorithm and based on a binary indicator function, x*ᵢⱼₖ (indicating whether or not to boost a sponsored item) as follows:

$$maximize {\sum }_{∀ i , j , k} {s}_{i j k} {x}_{i j k} \\ subject to {\sum }_{∀ k} {x}_{i j k} \leq {p}_{i j} ∀ i , j \\ {\sum }_{∀ j} {\sum }_{∀ k} {x}_{i j k} \leq {c}_{i} ∀ i \\ {\sum }_{∀ i} {\sum }_{∀ j} {\sum }_{∀ k} {x}_{i j k} \leq d \\ {x}_{i j k} ∈ \{ 0 , 1 \} ∀ i , j , k \\ {x}_{i j k} = 0 ∀ ( i , j , k ) where {ω}_{i j k} ∉ A \qquad eq . 2$$

where pᵢⱼ represents a lane limit indicating a maximum number of sponsored items for a j^{th} plane in the i^{th} carousel, cᵢ represents a carousel limit indicating a maximum number of sponsored items for the i^{th} carousel, and d indicates the maximum number of sponsored items that can be recommended for the entire website page. Further, x*ᵢⱼₖ=1 denotes that the sponsored item in position ijk should be boosted to a better position, and x*ᵢⱼₖ=0 denotes that the sponsored item in position ijk should not be boosted to a better position. In this way, item recommendation computing device 102 may determine an initial set of items for recommendation (and their corresponding positions) by optimizing the potential revenue from the sponsor items by placing sponsored items at positions that maximize the total scores of the presented sponsored items while staying within the constraints of the website page.

In some examples, item recommendation computing device 102 may relax the integer linear algorithm to determine the initial set of items and their corresponding positions in real-time. In such examples, the algorithm may be relaxed as follows:

$$maximize {\sum }_{∀ i , j , k} {s}_{i j k} {x}_{i j k} \\ subject to {\sum }_{∀ k} {x}_{i j k} \leq {p}_{i j} ∀ i , j \\ {\sum }_{∀ j} {\sum }_{∀ k} {x}_{i j k} \leq {c}_{i} ∀ i \\ {\sum }_{∀ i} {\sum }_{∀ j} {\sum }_{∀ k} {x}_{i j k} \leq d \\ 0 \leq {x}_{i j k} < 1 ∀ i , j , k \\ {x}_{i j k} = 0 ∀ ( i , j , k ) where {ω}_{i j k} ∉ A \qquad eq . 3$$

Where τ represents a predetermined boosting threshold, and τ<x*ᵢⱼₖ≤1 denotes that the sponsored item in position ijk should be boosted to a better position and 0≤x*ᵢⱼₖ≤τ denotes that the sponsored item in position ijk should not be boosted to a better position. Positions for the initial set of items may then be determined (or updated) in this way.

### Determine Item Recommendations

In some examples, item recommendation computing device 102 may determine whether there are still more sponsored items that could be added to the initial set of items for recommendation without violating the constraints. In some examples, item recommendation computing device 102 may update the constraints based on the initial set of items for recommendations as follows: (1) pane limit may be updated (e.g., to determine remaining pane limit) as pᵢⱼ→ [symbol] , (2) carousel limit may be updated (e.g., to determine remaining carousel limit) as cᵢ→ [symbol] , (3) page limit may be updated (e.g., to determine remaining pane limit) as d→\tilde{d}, and item ωᵢⱼₖ on the website page may be updated as positions in initial set of items as ωᵢⱼₖ→ [symbol] .

In some examples, item recommendation computing device 102 may utilize a blending model to meet the constraints when the page limit has not been met (e.g., \tilde{d}>0) to add more sponsored items to the final item recommendations. Item recommendation computing device 102 may increase sponsorship revenue further by injecting sponsored items to the item recommendations based on their similarity to an item in the initial set of items for recommendation when the constraints have not been met. In some examples, only items that are non-sponsored items in the initial set of items for recommendations may be considered for replacement. A subset of initial set of items may be selected randomly for replacement with corresponding closest similar sponsored items. For every item in the initial set of recommendations selected for replacement, item recommendation computing device 102 may attempt to maximize the sponsorship revenue while staying within the constraints based on cost scores of sponsored items as:

$$maximize {\sum }_{∀ i , j , k , a} {π}_{a} {x}_{ijka} \\ subject to {\sum }_{∀ i} {\sum }_{∀ j} {\sum }_{∀ k} {x}_{i j k a} \leq 1 ∀ a \\ {x}_{i j k a} = 0 ∀ i , j , k , a : {f}_{θ} ( {\tilde{ω}}_{ijk} , a ) \leq ϛ \\ {x}_{i j k a} = 0 ∀ i , j , k : {\tilde{ω}}_{i j k} ∈ A \\ {\sum }_{∀ k} {\sum }_{∀ a} {x}_{ijka} \leq {p}_{ij} ∀ i , j \\ {\sum }_{∀ j} {\sum }_{∀ k} {\sum }_{∀ a} {x}_{ijka} \leq ∀ i \\ {\sum }_{∀ i} {\sum }_{∀ k} {\sum }_{∀ k} {\sum }_{∀ a} {x}_{ijka} \leq \tilde{d} \\ {x}_{ijka} ∈ \{ 0 , 1 \} ∀ i , j , k , a \qquad eq . 4$$

where [symbol] represents a predetermined similarity threshold (e.g., constant) that may be used to determine when a particular closest similar sponsored item is similar enough to an initial item that it could be used as a replacement, ƒ_{θ}(\tilde{ω}ᵢⱼₖ, a) represents a functions for computing a similarity score between item \tilde{ω}ᵢⱼₖ at k^{th} position of the j^{th} pane and i^{th} carousel and a represents a potential sponsored item for replacing the item \tilde{ω}ᵢⱼₖ.

In some examples, item recommendation computing device 102 may utilize a universal sentence encoding algorithm based semantic similarity model to determine a sponsored product to replace a corresponding initial item selected for replacement. In such examples, each item in the retailer's catalog may be embedded in a high dimensional space based on metadata associated with the items. Metadata including item attributes, such as but not limited to, title, brand, department, category, etc. may be used to generate content embeddings using universal sentence encoding that encodes the items based on a similarity model that uses semantic similarity between two sentences to encode metadata. The semantic similarity between two items may then be computed using a cosine-similarity functions between the two item embeddings. For example, cosine-similarity score between two embeddings p and q may be determined as follows:

$${f}_{θ} ( p , q ) = cos ( θ ) = \frac{{p}^{T} q}{‖ p ‖ ‖ q ‖} \qquad eq . 5$$

In some examples, the similarity scores between an item and a sponsored item may be pre-computed. In other examples, the similarity scores between an item and a sponsored item may be computed in real-time.

In some examples, item recommendation computing device 102 may receive similarity model data from database 116 that maps every item in the catalog to the closest sponsored item based on semantic similarity between corresponding embeddings of the item and the sponsored items. Item recommendation computing device 102 may compute a closest similar sponsored item to an item in a catalog if the semantic similarity between the two is greater than the predetermined similarity threshold. Database 116 may store the pairings as key-value pairs for fast retrieval in real-time as mapping, M(ωᵢⱼₖ)∈A.

In some examples, item recommendation computing device 102 may uniformly sample N items from initial set of items randomly. The similarity model data may be used to extract closest sponsored items to the randomly selected sampled initial items from the initial set of items. The closest similar sponsored items corresponding to the sampled initial items may then be ranked based on decreasing cost scores. Item recommendation computing device 102 may then replace the initial item with the corresponding closest similar sponsored item for each initial item in the ranked order, if the constraints are not violated and if the sampled initial item is not a sponsored item until the maximum sponsored items constraints for the website page are met. The item recommendations may then be generated using the unreplaced initial items and the replacement closest similar sponsored items. The item recommendations, including the personalized set of sponsored and non-sponsored items in the optimized positions may then be presented to the user.

In some examples, item recommendation computing device 102 may generate item recommendations for a customer based on set of unreplaced items and the closest similar sponsored items used to replace certain initial items as described above.

Among other advantages, the embodiments allow for real-time inferencing of multiple models to generate item recommendations for a particular customer based on balancing the need for maximizing sponsorship revenue, meeting the maximum sponsored items constraints for a website page, and not compromising the relevancy of the recommendations for increased customer satisfaction. Distributing processing tasks prior to the current session, based on previously trained and saved embeddings, allows for more consistent throughput consistency, as well as a reduction in overall processing time. Moreover, the distribution of processing tasks allows for the use of more computationally intensive models, such as neural networks, which can capture non-linear relationships from trained data and may be better suited to estimate relationships on unseen data (e.g., real-time data).

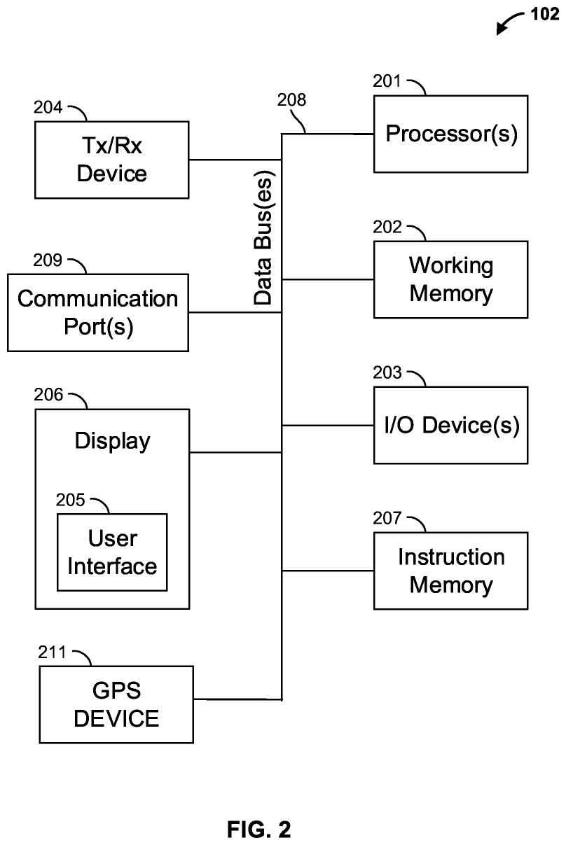

FIG. 2 illustrates the item recommendation computing device 102 of FIG. 1. Item recommendation computing device 102 can include one or more processors 201, working memory 202, one or more input/output devices 203, instruction memory 207, a transceiver 204, one or more communication ports 209, a display 206 with a user interface 205, and a global positioning system (GPS) device 211, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally, processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item recommendation computing device 102. Working memory 202 can be a random-access memory (RAM) such as a static random-access memory (SRAM) or dynamic random-access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning model training data.

Display 206 can be any suitable display, and may display user interface 205. User interfaces 205 can enable user interaction with item recommendation computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item recommendation computing device 102 will be operating in. Processor(s) 201 is operable to receive data from, or send data to, a network, such as communication network 118 of FIG. 1, via transceiver 204.

GPS device 211 may be communicatively coupled to the GPS and operable to receive position data from the GPS. For example, GPS device 211 may receive position data identifying a latitude, and longitude, from a satellite of the GPS. Based on the position data, item recommendation computing device 102 may determine a local geographical area (e.g., town, city, state, etc.) of its position. Based on the geographical area, item recommendation computing device 102 may determine relevant trend data (e.g., trend data identifying events in the geographical area).

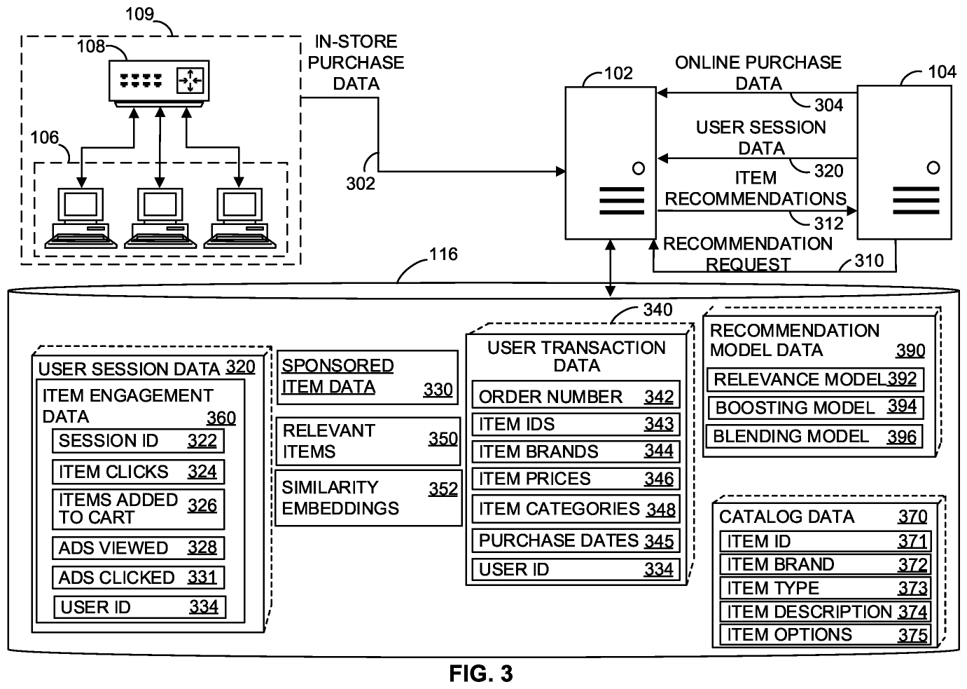

FIG. 3 is a block diagram illustrating examples of various portions of the item recommendation system 100 of FIG. 1. As indicated in the figure, item recommendation computing device 102 may receive user session data 320 from web server 104, and store user session data 320 in database 116. User session data 320 may identify, for each user (e.g., customer), data related to that user's browsing session, such as when browsing a retailer's webpage hosted by web server 104.

In this example, user session data 320 may include item engagement data 360. Item engagement data 360 may include one or more of a session ID 322 (i.e., a website browsing session identifier), item clicks 324 identifying items which the user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

Item recommendation computing device 102 may also receive online purchase data 304 from web server 104, which identifies and characterizes one or more online purchases, such as purchases made by the user via a retailer's website hosted by web server 104. Item recommendation computing device 102 may also receive in-store purchase data 302 from store 109, which identifies and characterizes one or more in-store purchases.

Item recommendation computing device 102 may parse in-store purchase data 302 and online purchase data 304 to generate user transaction data 340. In this example, user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item types 348 identifying a type (e.g., category) of each item purchased, a purchase date 345 identifying the purchase date of the purchase order, and user ID 334 for the user making the corresponding purchase.

Database 116 may further store catalog data 370, which may identify one or more attributes of a plurality of items, such as a portion of or all items a retailer carries. Catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

Database 116 may also store sponsored items data 330, which may identify and categorize each sponsored item available at the retailer's website. Sponsored items data 330 may include data related to sponsored items and their corresponding cost-per-click scores indicating corresponding revenues that are earned by the retailer for every user interaction with the sponsored items.

Additionally, database 116 may store relevant items 350, which may identify and categorize items relevant to the customer. The items may also be associated with corresponding relevancy scores indicating a relevancy of the items to the particular customer. The relevant items 350 may be determined using relevance model 392 also stored in database 116. Relevance model 392 may determine relevant items 350 and their corresponding score for the customer based on user session data 320 and/or user transaction data 340. Any known relevancy model may be used to determine the relevant items 350 and their corresponding scores for each user and/or each user session. Relevant items 350 may include data indicating a first set of items that are determined to be relevant to the user based on the user transactional data 340 and/or user session data 320 associated with past user sessions, as determined prior to the current user session by relevance model 392.

Database 116 may also store similarity embeddings 352 including similarity model data that maps every item in the catalog data 370 to the closest sponsored item based on semantic similarity between corresponding embeddings of the item and the sponsored items. Item recommendation computing device 102 may compute a closest similar sponsored item to an item in catalog data 370 if the semantic similarity between the two is greater than the predetermined similarity threshold. Similarity embeddings 352 may store the pairings as key-value pairs for fast retrieval in real-time as mapping, M(ωᵢⱼₖ)∈A. The embeddings may be based on language analysis of item ID 371, item brand 372, item type 373, item description 374, and/or item options 375 for each item (e.g., sponsored item, non-sponsored item).

Database 116 may also store recommendation model data 390 identifying and characterizing one or more machine learning models. For example, recommendation model data 390 may include the relevance model 392, a boosting model 394, and a blending model 396. Each of the relevance model 392, boosting model 394, and blending model 396 may be one or more machine learning models trained based on corresponding tensors (e.g., embedding vectors, feature vectors) generated by item recommendation computing device 102.

In some examples, item recommendation computing device 102 receives (e.g., in real-time) user session data 320 for a customer interacting with a website hosted by web server 104. In response, item recommendation computing device 102 generates item recommendations 312 identifying recommended items to advertise to the customer, and transmits item recommendation 312 to web server 104.

For example, item recommendation computing device 102 may assign each of the relevance model 392, boosting model 394, and blending model 396 (or parts thereof) to a different processing unit or virtual machines hosted by one or more processing devices 120. Moreover, item recommendation computing device 102 may generate tensors based at least on the received user session data 320 (e.g., the user session data 320 received in real-time) for the customer, the user transaction data 340 (e.g., the user transaction data 340 from prior or historical user sessions), and sponsored item data 330 as required by each of the relevance model 392, boosting model 394, and blending model 396. In some examples, item recommendation computing device 102 generates the tensors based on the received user session data 320, and one or more of the following: historical user session data 320 for the customer, historical user transaction data 340 for the customer, relevant items 350, sponsored item data 330, and similarity embeddings 352, for each of the relevance model 392, boosting model 394, and blending model 396. Item recommendation computing device 102 may provide (e.g., transmit) the tensors to the processing units accordingly, and the processing units may execute the models based on the provided tensors (e.g., inferencing).

Further, item recommendation computing device 102 may obtain the output (e.g., output data, output tensors) of each of the relevance model 392, boosting model 394, and blending model 396 from the processing units, and generate the item recommendation 312 based on the outputs of the models. For example, item recommendation computing device 102 may use boosting model 394 to manipulate the output of the relevance model 392 to boost the sponsored items in the relevant items 350 based on sponsored item data 330 (e.g., cost scores) to generate the initial set of items for recommendation. The blending model 396 may replace one or more initial items of the initial set of items with corresponding closest similar sponsored items based on a similarity score and constraints of the website page (e.g., pane limits, carousel limits, page limits) and generate a ranking (e.g., item ranking, positions) based on a combination of the model outputs. The item recommendations 312 may then be generated as the combination of the model outputs.

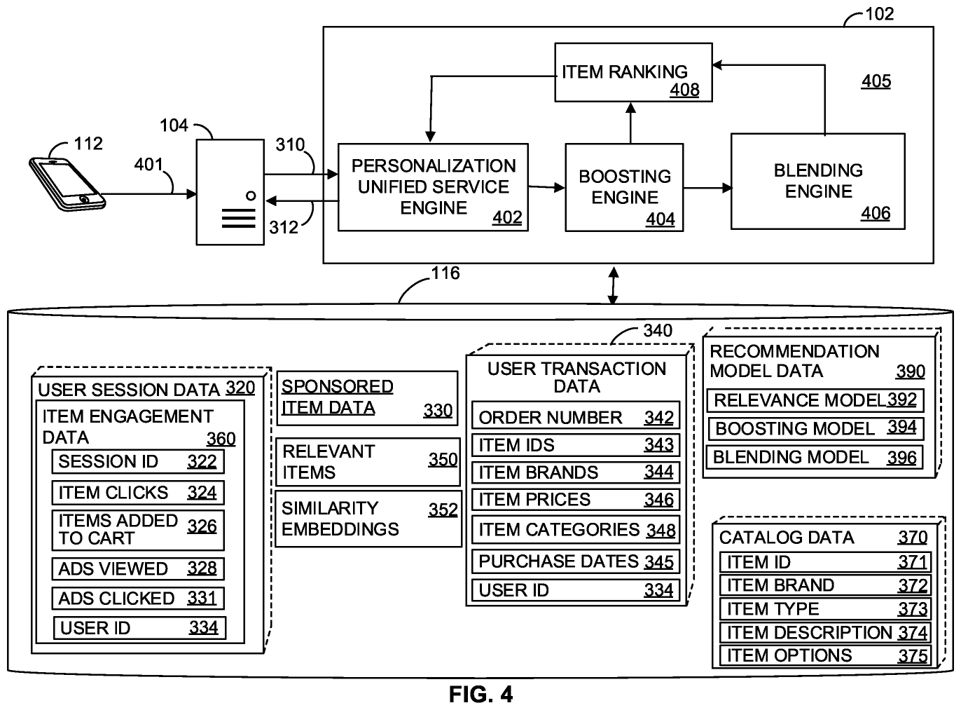

FIG. 4 is a block diagram illustrating a more detailed view of item recommendation computing device 102. Specifically, item recommendation computing device 102 includes FIG. 4 is a block diagram illustrating a more detailed view of item recommendation computing device 102. Specifically, item recommendation computing device 102 includes personalization unified service engine 402, boosting engine 404, and blending engine 406. In some examples, one or more of personalization unified service engine 402, boosting engine 404, and blending engine 406 are implemented in hardware. In some examples, one or more of personalization unified service engine 402, boosting engine 404, and blending engine 406 are implemented as an executable program maintained in a tangible, non-transitory memory, such as instruction memory 207 of FIG. 2, which may be executed by one or processors, such as processor 201 of FIG. 2. For example, personalization unified service engine 402 may obtain from database 116 recommendation request 310 as a message 401 from user device 112 via web server 104 and may execute recommendation model(s) included in the recommendation model data 390.

In this example, web server 104 transmits a recommendation request 310 to item recommendation computing device 102. Recommendation request 310 may include a request for item recommendations for presentation to a particular user using the user device 112. In some examples, recommendation request 310 further identifies a user (e.g., customer) for whom the item recommendations are requested at web server 104. Personalization unified service engine 402 receives recommendation request 310, and receives and parses the user session data 320 (e.g., user session data associated with a current user session of the user in real-time). Personalization unified service engine 402 provides to the boosting engine 404 the user session data 320, and other data, which may include the user transaction data 340, user session data 320 (e.g., user session data from historical user sessions), sponsored item data 330, and relevant items 350 extracted from database 116.

Boosting engine 404 can determine an initial set of items for recommendation (e.g., along with their corresponding positions) based on the user session data 320, the user transaction data 340, sponsored item data 330, and relevant items 350. Boosting engine 404 may use relevance model 392 and the boosting model 394 to determine the initial set of items and their positions for recommendation based on the user's historical purchase and/or session data for the particular user of user device 112, sponsored item data 330, and relevant items 350 extracted from the database 116 for the particular user. In some examples, boosting engine 404 may further use a thresholding algorithm to threshold the sponsored items included in the initial set of items to a predetermined number based on constraints on the maximum number of sponsored items that can be provided on the website page in every pane, every carousel, and/or every page. Boosting engine 404 generates ranked (e.g., positions) initial set of items for recommendation identifying and characterizing items determined to be relevant to the user and including sponsored items at positions that maximizes the revenue from sponsorships while retaining the relevancy of the recommendations. Boosting engine 404 may provide the initial set of items (e.g., with corresponding initial positions) to blending engine 406.

Blending engine 406 can determine final item recommendations 312 based on maximizing the number of sponsored items in the recommendation while staying with constraints by replacing one or more non-sponsored items in the initial set of items with closest similar sponsored items based on similarity embeddings 352. Boosting engine 404 may receive similarity embeddings 352 including closest similar sponsored item to each initial item randomly selected item for replacement. The closest similar sponsored item may replace the corresponding initial item based on a similarity score being above a threshold, and the number of sponsored items in the item recommendations being within the maximum thresholds. Closest similar sponsored items may be used to replace corresponding initial items based on descending cost scores of the closest sponsored item till no more sponsored items can be included in item recommendations without violating the maximum sponsored item constraints for the pane, carousel and/or website page. Item ranking 408 may be generated by blending engine 406 for item recommendations. The item ranking may be positions of the items in the item recommendations as determined by the blending engine. In some examples, initial set of items may be used as item recommendations and corresponding item ranking 408 when the maximum number of sponsored items are included in the initial set of items for each pane, carousel and page.

Item ranking 408 can determine an ordered list of the item recommendations 312 based on the item rankings received from the blending engine 406. Item ranking 408 may generate data that identifies the order and/or positions of item recommendations 312 associated with the particular user (e.g., customer) to optimize user interactions with and user purchases of items in the recommendations while also maximizing revenue from recommending sponsored items.

Personalization unified service engine 402 may receive the item recommendations 312 from the final ranking 408 in a data format (e.g., message) acceptable by web server 104. Personalization unified service engine 402 transmits the item recommendations 312 to web server 104. Web server 104 may then update or generate item recommendations for presentation to the user via the user device 112 based on the item ranking 408.

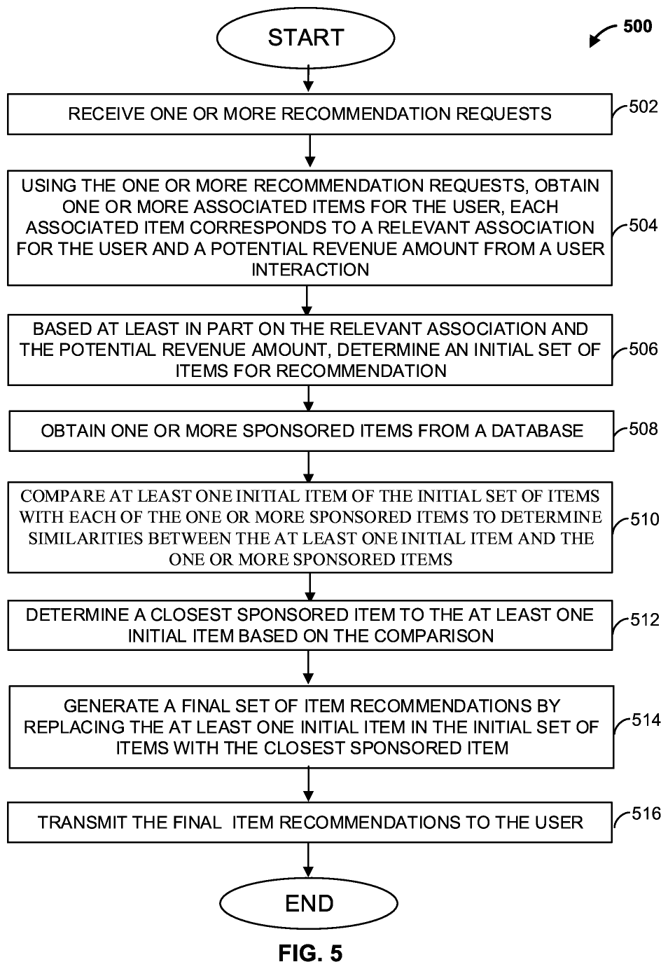

FIG. 5 is a flowchart of an example 500 that can be carried out by the item recommendation system 100 of FIG. 1. Beginning at step 502, one or more recommendation requests are received related to a user. For example, item recommendation computing device 102 may receive a recommendation request 310 from web server 104. At step 504, one or more associated items are obtained for the user using the one or more recommendation requests. Each associated item corresponds to a relevant association for the user and a potential revenue amount from a user interaction. For example, relevant items 350 are obtained from database 116. The relevant items 350 may include sponsored items and non-sponsored items, each relevant item may have a corresponding relevant association (e.g., relevant to the user) for the user, and each relevant item may have a corresponding cost to click revenue (e.g., zero for non-sponsored items, and a sponsorship revenue for sponsored items).

At step 506, an initial set of items for recommendation is determined based at least in part the relevant association and the potential revenue amount. For example, boosting engine 404 may determine an initial set of items based on relevant items 350 and sponsored item data 330 (e.g., cost scores associated with sponsored items). At step 508, one or more sponsored items are obtained from the database. For example, item recommendation computing device 102 may obtain sponsored item data 330 from database 116.

At step 510, at least one initial item of the initial set of items is compared with each of the one or more sponsored items to determine similarities between the at least one initial item and the one or more sponsored items. For examples, item recommendation computing device 102 may utilize similarity embeddings 352 to compare an item and other sponsored items to determine similarity scores between sponsored items and an initial item in the initial set of items. At step 512, a closest sponsored item to the at least one initial item is determined based on the comparison. For example, blending model 396 may determine a closest sponsored item to an initial item in the initial set of items based on the similarity embeddings 352.

At step 514, a final set of item recommendations may be generated by replacing the at least one item in the initial set of items with the closest sponsored item. For example, blending engine 406 may generate item recommendations 312 based on final ranking 408 determined by replacing one or more non-sponsored items in the initial set of items for recommendation with corresponding similar (or closest) sponsored items most similar to their counterpart initial item.

At step 516, the final set of item recommendations are transmitted to the user. For example, item recommendation computing device 102 may transmit the item recommendations 312 to web server 104 for presentation to the user via user device 112. The method then ends.

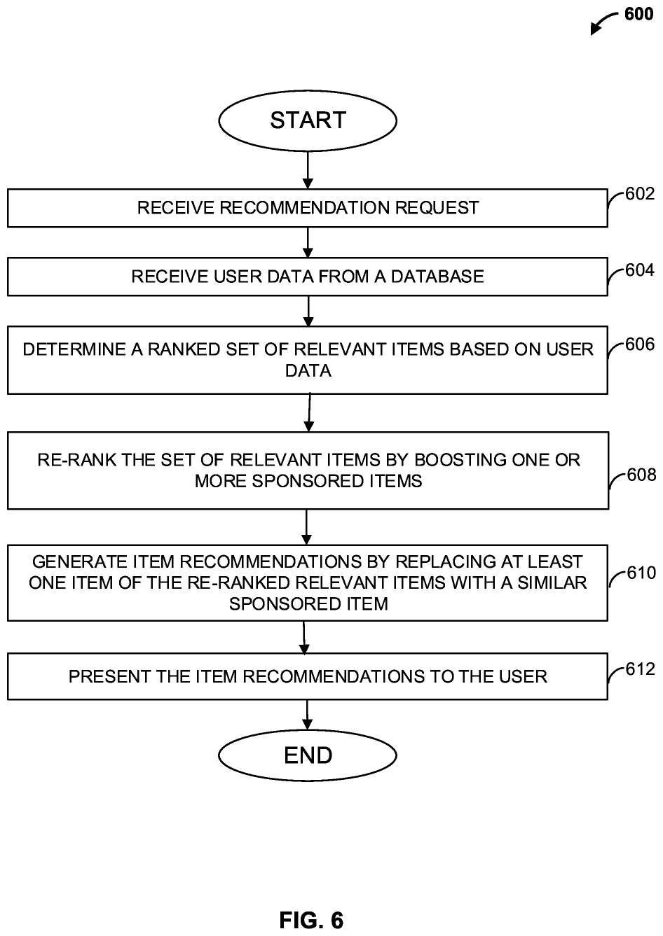

FIG. 6 is a flowchart of an example method 600 that can be carried out by the digital item recommendation system 100 of FIG. 1. At step 602, a computing device, such as item recommendation computing device 102, receives a recommendation request. For example, item recommendation computing device 102 may receive a recommendation request 310 from web server 104. At step 604, user data is received from a database. For example, item recommendation computing device 102 may obtain the user session data and/or user transaction data for the user from database 116, which stores user session data 320 and user transaction data 340 for a plurality of users.

Proceeding to step 606, a ranked set of relevant items are determined based on the user data. For example, relevant items 350 for the user along with their ranks and/or positions may be determined by relevance model 392. At step 608, the set of relevant items may be re-ranked by boosting one or more sponsored items in the set of relevant items. For example, boosting model 394 may re-rank the relevant items 350 to put relevant sponsored items at better positions based on cost scores to generate initial set of items for recommendation.

At step 610, item recommendations are generated by replacing at least one item of the re-ranked relevant items with a similar sponsored item. For example, blending model 396 may generate item recommendations 312 by replacing one or more non-sponsored items in the initial set of items for recommendation with corresponding similar sponsored items most similar to their counterpart initial item based on similarity embeddings 352.

At step 612, the item recommendations are presented to the user. For example, item recommendation computing device 102 may transmit the item recommendations 312 to web server 104 for presentation to the user via user device 112. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

1. A system comprising:
a memory having instructions stored thereon, and a processor configured to read the memory, wherein the processor is communicatively coupled to a database, and wherein the processor is configured to read the instructions to:
receive, from a server and via a communications network, one or more recommendation requests related to a user;
using the one or more recommendation requests, obtain, from the database, one or more associated items for the user, each associated item corresponds to a relevant association for the user and a potential revenue amount from a user interaction;
based at least in part on the relevant association and the potential revenue amount, determine, via the processor of the server, an initial set of items for recommendation, the initial set of items including a portion of the one or more associated items;
obtain one or more sponsored items from the database;
compare, via the processor, at least one initial item of the initial set of items with each of the one or more sponsored items to determine similarities between the at least one initial item and the one or more sponsored items;
determine, via the processor, a closest sponsored item to the at least one initial item based on the comparison;
generate, via the processor, a final set of item recommendations by replacing the at least one initial item in the initial set of items with the closest sponsored item; and
transmit, via the communications network, the final set of item recommendations to the server, causing the server to provide at least one item advertisement for the final set of item recommendations for presentation to the user through a display interface of a user device.

2. The system of claim 1, wherein the processor is further configured to read the instructions to:
for each associated item, determine a relevance score, based on the user data, indicating the relevant association for the user;
for each associated item, obtain a cost score, indicating the potential revenue amount from a user interaction;
for each associated item, determine a total relevance score based on the relevance score and the cost score; and
determine the initial set of items based on the corresponding total relevance scores, the initial set of items including ranks of the initial items based on the corresponding total relevance scores.

3. The system of claim 2, wherein the cost score for an associated item that is not a sponsored item is zero.

4. The system of claim 1, wherein the initial set of items are determined based at least in part on a carousel limit, a pane limit and a page limit.

5. The system of claim 1, wherein the initial set of items includes at least one sponsored item and at least one non-sponsored item.

6. The system of claim 5, wherein the at least one initial item that is replaced by the closest sponsored item is the at least one non-sponsored item.

7. The system of claim 1, wherein the at least one initial item that is replaced is selected randomly, and a number of initial items of the initial set of items to be replaced is determined based at least in part on a number of sponsored items included in the initial set of items for recommendation.

8. The system of claim 1, wherein the closest sponsored item is selected based on an item and sponsored-item embedding generated based on semantic similarity.

9. A method by at least one processor, the method comprising:
receiving, from a server, one or more recommendation requests related to a user;
using the one or more recommendation requests, obtaining, from a database, one or more associated items for the user, each associated item corresponds to a relevant association for the user and a potential revenue amount from a user interaction;
based at least in part on the relevant association and the potential revenue amount, determining an initial set of items for recommendation, the initial set of items including a portion of the one or more associated items;
obtaining, from the database, one or more sponsored items from a database;
comparing at least one initial item of the initial set of items with each of the one or more sponsored items to determine similarities between the at least one initial item and the one or more sponsored items;
determining a closest sponsored item to the at least one initial item based on the comparison;
generating a final set of item recommendations by replacing the at least one initial item in the initial set of items with the closest sponsored item; and
transmitting the final set of item recommendations to the server, causing the server to provide at least one item advertisement for the final set of item recommendations for presentation to the user through a display interface of a user device.

10. The method of claim 9, the method further comprising:
for each associated item, determining a relevance score, based on the user data, indicating the relevant association for the user;
for each associated item, obtaining a cost score, indicating the potential revenue amount from a user interaction;
for each associated item, determining a total relevance score based on the relevance score and the cost score; and
determining the initial set of items based on the corresponding total relevance scores, the initial set of items including ranks of the initial items based on the corresponding total relevance scores.

11. The method of claim 10, wherein the cost score for an associated item that is not a sponsored item is zero.

12. The method of claim 9, wherein the initial set of items are determined based at least in part on a carousel limit, a pane limit and a page limit.

13. The method of claim 9, wherein the initial set of items includes at least one sponsored item and at least one non-sponsored item.

14. The method of claim 13, wherein the at least one initial item that is replaced by the closest sponsored item is the at least one non-sponsored item.

15. The method of claim 9, wherein the at least one initial item that is replaced is selected randomly, and a number of initial items to be replaced is determined based at least in part on a number of sponsored items of the initial set of items included in the initial set of items for recommendation.

16. The method of claim 9, wherein the closest sponsored item is selected based on an item and sponsored-item embedding generated based on semantic similarity.

17. A non-transitory computer readable medium having instructions stored thereon, wherein the instructions, when executed by at least one processor, cause a device to perform operations comprising:
receiving, from a server and via a communications network, one or more recommendation requests related to a user;
using the one or more recommendation requests, obtaining one or more associated items for the user, each associated item corresponds to a relevant association for the user and a potential revenue amount from a user interaction;
based at least in part on the relevant association and the potential revenue amount, determining an initial set of items for recommendation, the initial set of items including a portion of the one or more associated items;
obtaining one or more sponsored items from a database;
comparing at least one initial item of the initial set of items with each of the one or more sponsored items to determine similarities between the at least one initial item and the one or more sponsored items;
determining a closest sponsored item to the at least one initial item based on the comparison;
generating a final set of item recommendations by replacing the at least one initial item in the initial set of items with the closest sponsored item; and
transmitting, via the communications network, the final set of item recommendations to the server, causing the server to provide at least one item advertisement for the final set of item recommendations for presentation to the user through a display interface of a user device.

18. The non-transitory computer readable medium of claim 17, the operations further comprising:
for each associated item, determining a relevance score, based on the user data, indicating the relevant association for the user;
for each associated item, obtaining a cost score, indicating the potential revenue amount from a user interaction;
for each associated item, determining a total relevance score based on the relevance score and the cost score; and
determining the initial set of items based on the corresponding total relevance scores, the initial set of items including ranks of the initial items based on the corresponding total relevance scores.

19. The non-transitory computer readable medium of claim 17, wherein the cost score for an associated item that is not a sponsored item is zero.

20. The non-transitory computer readable medium of claim 17, wherein the initial set of items are determined based at least in part on a carousel limit, a pane limit and a page limit.
